(19) United States
(12) Patent Application Publication
(10) Pub. No.: US 2006/0059945 A1
(43) Pub. Date: Mar. 23, 2006

(54) Method for single-phase supercritical carbon dioxide cooling

(76) Inventors: Lalit Chordia, Pittsburgh, PA (US); John C. Davis, Pittsburgh, PA (US)

Correspondence Address: Lalit Chordia, 730 William Pitt Way, Pittsburgh, PA, 15238, US

(21) Appl. No.: 11/225,386

(22) Filed: Sep. 13, 2005

Related U.S. Application Data
(60) Provisional application No. 60/609,279, filed on Sep. 13, 2004.

(51) Int. Cl. F25B 1/00; C09K 5/04

(52) U.S. Cl. 62/498; 62/114

(57) ABSTRACT

A cooling cycle is disclosed employing carbon dioxide in a supercritical state throughout the cycle. Heat absorption depends solely on the heat capacity of the fluid as it flows through the hot zone. Consequently, there is no change of state, as would be the case in evaporative heat absorption. The supercritical carbon dioxide is maintained above the dew point that could be expected for devices operating indoors or outdoors.

### CROSS-REFERENCE TO RELATED APPLICATION

This application claims priority from the U.S. provisional patent application of the same title, which was filed on Sep. 13, 2004 and was assigned U.S. patent application Ser. No. 60/609,279, teachings of which are incorporated herein by reference.

### BACKGROUND OF THE INVENTION

There are numerous options available for cooling devices that would otherwise build up hot spots during operation that could impair performance. A typical example is in electronics, where integrated circuits can heat up to temperatures approaching 100° C., at a cost in reliability, speed and other performance factors. Some type of direct cooling is applied to these chips to keep the temperature from rising too far.

A simple cooling method is to attach a heat sink to a chip so as to extend its ability to radiate heat. These heat sinks can be finned to provide greater surface area. Fans can improve the circulation of cooling air over these sinks.

If forced air proves insufficient to the cooling task, various enhancements to the heat sink are available. One is to lower its temperature by means of thermoelectric, or Peltier, cooling. This method is precise and easily controlled, but it requires more energy input than it can remove from the hot device. Cooling fluids, which can be circulated through small channels in the heat sink, have the potential for removing more heat than is required to drive them around a cooling apparatus, which may include a separate heat exchanger, called a heat-rejecting heat exchanger, for purposes of exhausting the absorbed heat to the environment.

Such coolants can be gaseous or liquid, or in the case of liquid evaporation, both. In the typical refrigeration cycle, for example, liquid coolant evaporates as it absorbs heat from the hot device. Then it is compressed to a substantially higher pressure and forced through a heat-rejecting heat exchanger, where it might also condense to a liquid state, after which it is de-pressurized, or expanded adiabatically, to the temperature and liquid state required for the heat-accepting heat exchanger inlet. In this way, the inlet temperature can be brought to below ambient.

Carbon dioxide (CO₂) can be made to behave in just this way without ever exceeding the critical pressure. Alternatively, if compression takes the fluid into the supercritical region, then heat rejection will occur without condensation. Condensation occurs later during expansion. This type of cycle is typically called a transcritical cycle.

Transcritical CO₂ cycles work best if the heat-accepting heat exchanger inlet fluid temperature is in a range of about 25° C. or less. Between 25° C. and the critical temperature of 31° C., the amount of latent heat that can be absorbed in evaporation narrows substantially, reaching zero at the critical point. The supercritical cycle described herein expands the range of possible temperatures at the heat-accepting heat exchanger to well beyond the critical temperature. This could prove advantageous in many electronics cooling applications, especially portable computing, for which variations in climate and humidity could be great.

In most other respects, carbon dioxide is an excellent cooling fluid. Viscosity, especially in the supercritical state, is low, thereby minimizing the energy needed to pump it. A lower range of density differential between high and low pressures allows for smaller compressors, compared to fluorocarbon-based refrigerants such as R-134a.

Thus, what is needed is a way to utilize carbon dioxide in a temperature range that is closer to ideal for certain electronic cooling applications. In our previous disclosures, including U.S. Pat. No. 6,698,214, cooling is accomplished through the use of a transcritical cycle. The present invention provides cooling via a supercritical cycle.

### BRIEF SUMMARY OF THE INVENTION

The present invention discloses a method for cooling a device using carbon dioxide in a supercritical state as the cooling fluid, comprising the following process steps: [i] absorption of heat from said device by supercritical carbon dioxide, which flows through a heat-accepting heat exchanger that is in direct contact with said device; [ii] compression of said supercritical carbon dioxide after it exits said heat-accepting heat exchanger; [iii] transfer of said absorbed heat carried by said supercritical carbon dioxide to an ambient medium by means of a heat-rejecting heat exchanger and; [iv] pressure reduction in an expander that allows the passage of supercritical carbon dioxide from the outlet of said heat-rejecting heat exchanger to the inlet of said heat-accepting heat exchanger.

### BRIEF DESCRIPTION OF THE DRAWINGS

FIG. 1 illustrates a plot showing heat capacity as a function of temperature for pressures ranging between 80 and 125 bar.

FIG. 2 illustrates a single-phase supercritical thermodynamic cycle along with examples of temperature and pressure that might be found at various points along the cycle.

FIG. 3 illustrates the various elements of a single-phase thermodynamic cycle, including a heat-accepting heat exchanger, compressor, heat-rejecting heat exchanger and an expander.

### DETAILED DESCRIPTION

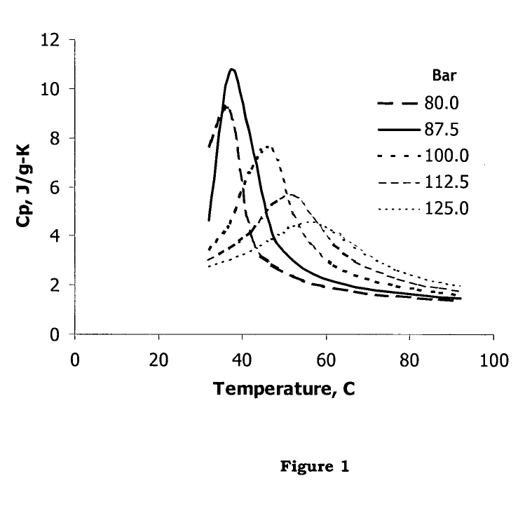

In the case of carbon dioxide, large increases in enthalpy occur with small increases in temperature just above the critical pressure in the supercritical regime. This is because the heat capacity is unusually high in this region. This effect exists only through a narrow pressure range starting at the critical pressure (72 bar), where it is most noticeable, and lessening as pressure rises. This variation can be seen in FIG. 1, which plots temperature and heat capacity for a family of pressure isotherms. All points along these curves are in the supercritical region. At 125 bar, the effect is barely one-third the size of the salient seen at 80 bar.

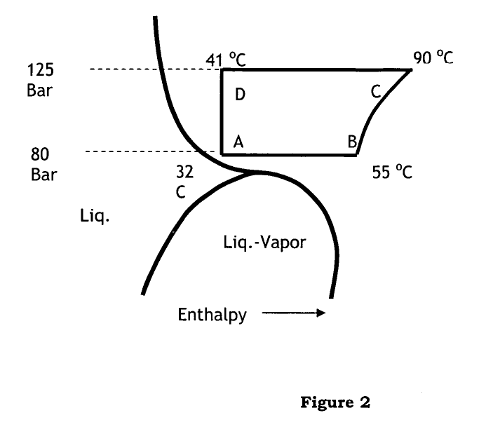

This high heat capacity is put to use in the thermodynamic cooling cycle depicted in FIG. 2. The temperatures chosen for this cycle satisfy two otherwise contradictory needs: (1) the need to capture the benefit from the heat capacity “spike”; and (2) provide coolant at temperatures that are above the dew point in most climates, i.e., above 20° C. in temperate climates and above 25° C. in tropical ones. Inspection of FIG. 1 for the temperature range of 32° C. to 55° C., at 80 bar, as shown for the heat acceptance path A→B in FIG. 2, shows that the first of these needs is, indeed, satisfied. It is understood that the temperature of carbon dioxide can drop below its critical temperature, so long as the pressure remains above the critical pressure, to satisfy the definition of supercritical as employed in this disclosure, because no condensation occurs.

The second need, optimization of the cooling temperature for electronics applications, depends on temperatures expected at the junction point between the device being cooled and the heat-accepting heat exchanger, as well as the temperature of the ambient cooling medium, which is usually air. Such air is typically forced through an electronic apparatus by fans and may exhibit a temperature that is higher than that of normal room air because it circulates through said apparatus. Device junction temperatures are quite high—too high to be touched safely by the hand without being burned. This is considerably higher than the fluid temperature in the heat-accepting heat exchanger, and it is possible to effect the transfer of heat with a heat exchanger that is small and economical. At the heat-rejecting heat exchanger side, shown in FIG. 2 as path C→D, the temperature of the cooling air can be expected to be about 40° C. or less, which is much less than the fluid temperature at the inlet to the heat-rejecting heat exchanger (90° C.), although this differential narrows at the outlet. Overall, this profile for temperature differential allows for compact, economical construction of the heat-rejecting heat exchanger as well.

The temperatures and pressures noted on FIG. 2 are but one example taken from a wide range of possibilities, and the present invention is by no means limited to the specific conditions of FIG. 2. Instead, this disclosure specifies pressures that are above the critical pressure. In a preferred embodiment of this disclosure, the pressure ranges from the critical pressure to up to 200 bar at the compressor outlet, along with higher temperatures that are commensurate with the conditions of pressure achieved.

Another aspect of the second need, optimization of electronics cooling temperature, is the avoidance of dew point. The dew point depends on the ambient conditions of temperature and humidity which not only change as the day goes by, but change within typical ranges depending on geography and season. Guidelines suggested by the Am. Soc. of Heating, Refrigeration and Air-conditioning Engineers (ASHRAE) put this design temperature at 28° C. A fluid cooled to a lower temperature faces a risk of causing water condensation on system devices, at least some of the time. The cycle as disclosed in the current invention keeps temperatures above this level, and so it runs very little risk of water condensation.

The cycle path B→C in FIG. 2 describes compression from the low-pressure heat accepting side of the cycle to the high-pressure heat rejecting side, with the understanding that even the low-side pressure is at all times above the critical pressure of 73.83 bar. Compression follows a nearly isentropic path, inefficiencies notwithstanding, resulting in a slightly curved route. Expansion through the expander, D→A, is sudden and adiabatic, as evidenced by a straight vertical path. Depending on the expander, decompression can come close to or become isentropic. The heat expelled in the heat-rejecting heat exchanger, shown as the enthalpy difference from C→D, is the sum of heat absorbed in the heat-accepting heat exchanger (A→B) and compression work (B→C). The lower heat capacity at this higher pressure results in a sharp drop in temperature between C→D, followed by a further drop during expansion from D→A. Thus, this cycle is similar to an evaporative refrigeration cycle, with the difference that the “spike” in heat capacity substitutes for the latent heat of evaporation as the main contributor to cycle efficiency.

As a consequence, the theoretical coefficient of performance for the specific cycle shown in FIG. 2 is high, calculated to be 9.1 (heat removed divided by compression work inputted). By way of contrast, a carbon dioxide transcritical cycle, operating at 46 bar on the low side and 110 bar on the high side, would achieve a COP only about half as high, despite the advantage of the latent heat of evaporation.

A comparison with R-134a in a vapor-liquid cycle also shows advantages for the single-phase supercritical carbon dioxide cycle as disclosed in the current invention. The volumetric flow rate of CO₂, for a given amount of heat removal, is not quite half that required of R-134a. This allows for the use of a smaller heat-rejecting heat exchanger. Additionally, a smaller ratio of inlet-to-outlet density through the compressor, compared to R-134a, allows for a smaller compressor. Lastly, carbon dioxide is environmentally benign, while R-134a, along with other fluorocarbon-based refrigerants, is associated with the atmospheric greenhouse effect.

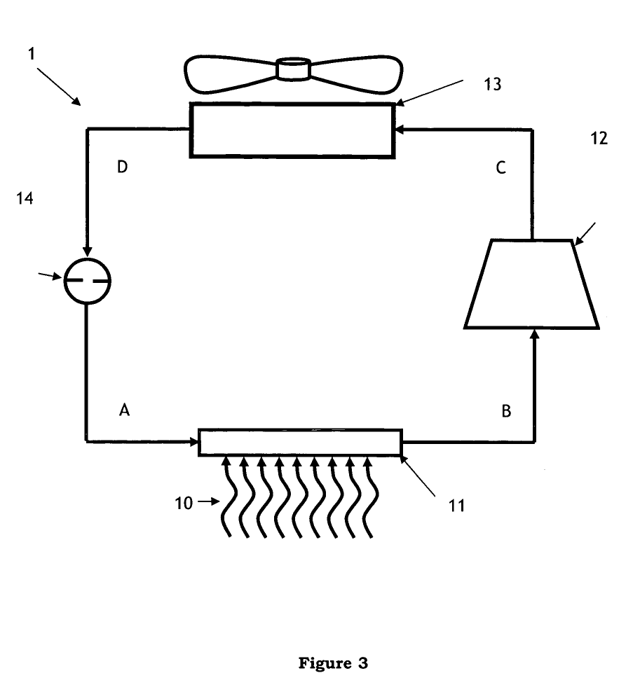

The basic components of a system employing single-phase supercritical carbon dioxide as the coolant are shown in FIG. 3. The cooling loop 1 serves to absorb heat 10 emanating from a heat-generating device by circulating cool supercritical fluid through heat-accepting heat exchanger 11. For the sake of clarity, it is to be understood that in the present invention, carbon dioxide is converted to a supercritical state by means of a separate device and is loaded into the cooling loop as a supercritical fluid. The heat-accepting heat exchanger may be constructed in any of several manners known to the art of small heat exchanger design, including but not limited to embedded channels or microchannels, or open-cell foam.

Because carbon dioxide is in a supercritical state as it passes through the heat-accepting heat exchanger 11, no evaporation occurs within the heat-accepting heat exchanger 11. Upon exiting the heat-accepting heat exchanger 11, carbon dioxide flows to the suction of a compressor 12. The output from the compressor 12 flows to the heat-rejecting heat exchanger 13, which, for illustrative purposes only, is shown in FIG. 3 as a cross-flow air-cooled heat exchanger. It is understood, however, that other means of heat exchange are possible in the heat-rejecting heat exchanger 13, including but not limited to exchange with a liquid or other gas in cross-flow, counter-flow or parallel-flow configurations. From the heat rejecting heat exchanger, carbon dioxide flows through the expander 14, whereupon pressure and temperature are reduced to the conditions desired for re-entry to the heat-accepting heat exchanger 11. The expander may be of a type that incorporates a constriction of fixed or variable dimension. If it is of the variable type, it may also be subject to some type of automatic control that adjusts the opening of the constriction based on conditions elsewhere in the system. This in turn may control the pressure and flow of carbon dioxide. Other possible controls include speed control of the compressor for purposes of varying the flow rate and pressure characteristics of carbon dioxide. Additionally, it may be desirable to include a vessel that acts as a reservoir of carbon dioxide at some point in the cycle. A system for separating lubricating oil, which might be carried by the carbon dioxide, is also an option. In that event, provision is made for recycling oil to suction of the compressor.

FIG. 3 contains letter references (A, B, C and D) that correspond to the same references that are found in FIG. 2, which describes the cycle. All of these components combined can be of a size that would fit into computing equipment, including portable computers. Such an integrated unit would be preloaded and sealed with carbon dioxide within at a pressure that is approximately midway between the low- and high-side pressure that would be expected during operation. Upon startup of the compressor, as for example when the temperature of heat source reaches a certain threshold, the pressure within the sealed unit would begin to differentiate into these high- and low-side values.

We claim:

1. A method for cooling a device using carbon dioxide in a supercritical state as the cooling fluid, comprising the following process steps:
a Absorption of heat from said device by supercritical carbon dioxide, which flows through a heat-accepting heat exchanger;
b Compression of said supercritical carbon dioxide after it exits said heat-accepting heat exchanger;
c Transfer of said absorbed heat carried by said supercritical carbon dioxide to an medium by means of a heat-rejecting heat exchanger and;
d Pressure reduction in an expander that allows the passage of supercritical carbon dioxide from the outlet of said heat-rejecting heat exchanger to the inlet of said heat-accepting heat exchanger.

2. The method as in claim 1 wherein the pressure and temperature at said inlet of said heat-accepting heat exchanger are close to the critical point.

3. The method as in claim 2 wherein the heat capacity is maximized at said inlet of said heat-accepting heat exchanger.

4. The method as in claim 1 wherein said temperature of said supercritical carbon dioxide is maintained above the dew point of the environment that surrounds said device being cooled.

5. The method as in claim 1 wherein said supercritical carbon dioxide is free or substantially free of lubricating oil.

6. The method as in claim 1 wherein flow of said supercritical carbon dioxide is controlled in part by adjusting the speed of said compressor.

7. The method as in claim 1 wherein said pressure and flow rate of said supercritical carbon dioxide are controlled at least in part by adjusting the dimensions of said expander.

8. The method as in claim 1 wherein a reservoir of excess supercritical carbon dioxide is maintained in a vessel.

9. The method as in claim 1 wherein said medium is air at ambient temperature.
